(19) United States
(12) Patent Application Publication
(10) Pub. No.: US 2014/0145981 A1
(43) Pub. Date: May 29, 2014

(54) WRITING DEVICE

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/967,355

(22) Filed: Aug. 15, 2013

(30) Foreign Application Priority Data
Nov. 29, 2012 (TW) 101144832

(51) Int. Cl. G06F 3/041; G06F 3/0354

(52) U.S. Cl. CPC G06F 3/041; G06F 3/03545
USPC 345/173; 345/179

(57) ABSTRACT

A writing device includes a writing pen and a light emitting diode display panel. The light emitting diode display panel includes an array having a plurality of pixels arranged in a matrix and a touch panel. Each of the pixels includes first, second and third light sources and a control circuit. The touch panel is electrically connected with the array. The touch panel senses a contact of the writing pen thereon and generates a control signal to the control circuit. The control circuit turns on one of the first, second and third light sources according to the control signal. When the writing pen moves on the touch panel, the first, second or third light sources of the pixels on a moving track of the writing pen are sequentially turned on to illustrate the moving track of the writing pen on the touch panel.

### BACKGROUND

1. Technical Field

The disclosure generally relates to a writing device, and particularly to an electronic blackboard having a light emitting diode display panel and a writing pen used in combination with the display panel.

2. Description of Related Art

In traditional blackboard, a lot of dust is generated when writing words/marks on or erasing the words/marks from the blackboard. The dust not only pollutes the environments, but also is harmful to health.

What is needed, therefore, is a writing device to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an illustrating view showing a writing device in accordance with an embodiment of the present disclosure.

FIG. 2 is an illustrating view of a light emitting diode display panel in FIG. 1.

FIG. 3 is an enlarged view of a part of the light emitting diode display panel in FIG. 2.

### DETAILED DESCRIPTION

An embodiment of a writing device will now be described in detail below and with reference to the drawings.

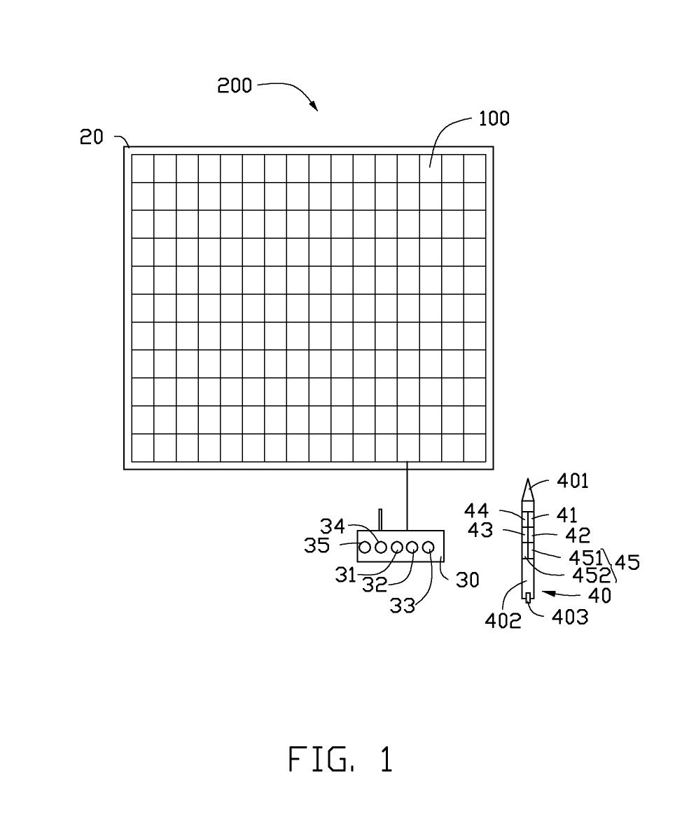

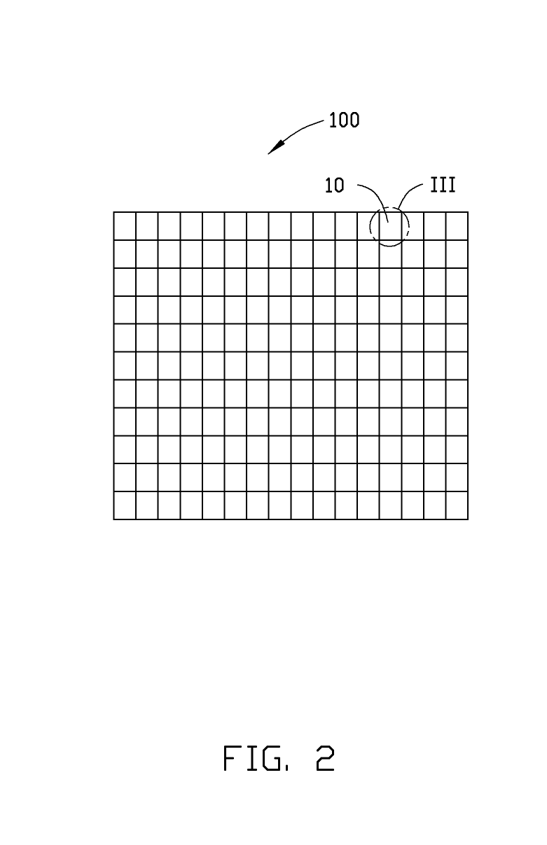

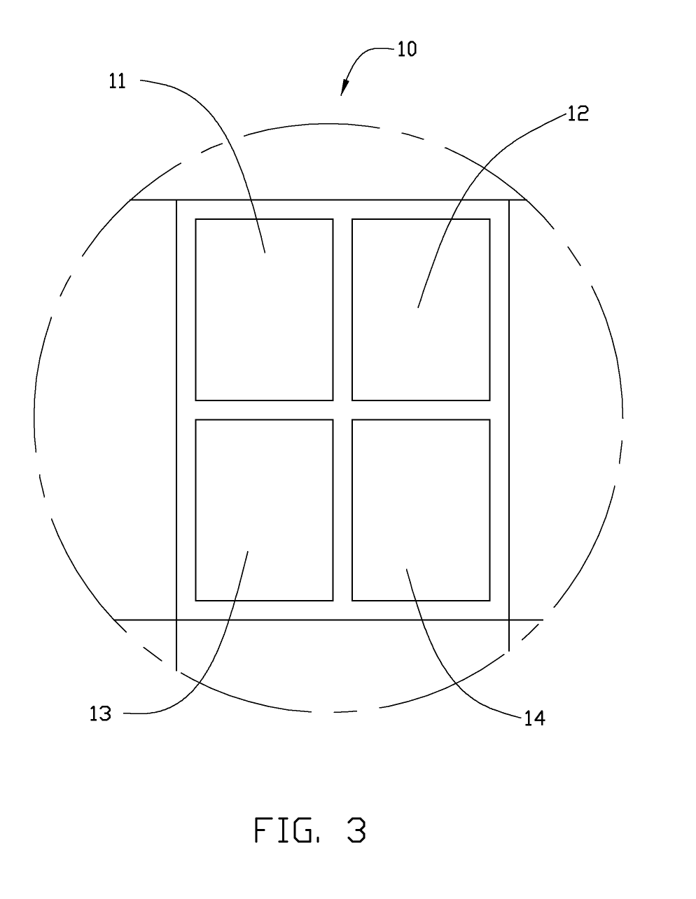

Referring to FIG. 1, the writing device which is an electronic blackboard includes a light emitting diode display panel 200 and a writing pen 40 to write words/marks on the light emitting diode display panel 200. Referring also to FIGS. 2-3, the light emitting diode display panel 200 includes an array 100 having a plurality of pixels 10 arranged in a matrix, a touch panel 20 and a receiver 30. The number of the pixels 10 is determined by an area of the light emitting diode display panel 200. An increase of the number of the pixels 10 will improve a viewing quality of the light emitting diode display panel 200.

Each of the pixels 10 includes a first light source 11, a second light source 12, a third light source 13 and a driving circuit 14. The first light source 11, the second light source 12, the third light source 13 and the driving circuit 14 are arranged in a matrix. In this embodiment, the first light source 11 emits red light, the second light source 12 emits green light and the third light source 13 emits blue light. The driving circuit 14 is configured to selectively turn on at least one of the first light source 11, the second light source 12 and the third light source 13. The touch panel 20 covers on the array 100. In this embodiment, the touch panel 20 is transparent and a surface of the touch panel 20 away from the array 100 is covered with a glass. The touch panel 20 is electrically connected with the driving circuit 14. The touch panel 20 senses a contact of the writing pen 40 and generates a control signal to the control circuit 14 after sensing the contact of the writing pen 40. According to the control signal from the touch panel 20, the control circuit 14 turns on at least one of the first light source 11, the second light source 12, and the third light source 13 in the pixels 10. When the writing pen 40 moves on the touch panel 20, the pixels 10 on a moving track of the writing pen 40 are sequentially turned on to illustrate the moving track of the writing pen 40 on the touch panel 20. Therefore, the moving track of the writing pen 40 on the touch panel 20 is illustrated by the light emitting diode display panel 200.

The writing pen 40 includes a first portion 401, a second portion 402 and a third portion 403. The second portion 402 extends from the first portion 401. The third portion 403 extends from one end of the second portion 402, along a direction away from the first portion 401. The first portion 401 of the writing pen 40 is configured to contact the touch panel 20. The second portion 402 is configured as a handle for a user to grip. The third portion 403 is configured as a switch to turn on or turn off the writing pen 40. When the writing pen 40 is not in operation, the user can turn off the writing pen 40 to save the power of a battery (not shown) in the writing pen 40. The third portion 403 can further act as a power socket to electrically connect with an external power to charge the battery in the writing pen 40. In this embodiment, the second portion 402 of the writing pen 40 includes a first selective button 41, a second selective button 42, a third selective button 43, a fourth selective button 44 and a fifth selective button 45. When the first selective button 41 is pressed down, the writing pen 40 generates a first signal to the control circuit 14 to turn on the first light source 11 only when the writing pen 40 contacts the touch panel 20. When the second selective button 42 is pressed down, the writing pen 40 generates a second signal to the control circuit 14 to turn on the second light source 12 only when the writing pen 40 contacts the touch panel 20. When the third selective button 43 is pressed down, the writing pen 40 generates a third signal to the control circuit 14 to turn on the third light source 13 only when the writing pen 40 contacts the touch panel 20. When the fourth button 44 is pressed down, the writing pen 40 generates a fourth signal to the control circuit 14 to turn on all of the first light source 11, the second light source 12, and the third light source 13 when the writing pen 40 contacts the touch panel 20. When the fifth button 45 is pressed down, the writing pen 40 generates an erasing signal to the control circuit 14 to turn off the lightened pixels 10. In this embodiment, the fifth button 45 consists of a first section 451 and a second section 452. When the first section 451 is pressed down, the writing pen 40 generates an erasing signal to turn off all of the lightened pixels 10 in the light emitting diode display panel 200. When the second section 452 is pressed down, the writing pen 40 generates an erasing signal to turn off only a part of the pixels 10 in the light emitting diode display panel 200 which is corresponding to a part of the touch panel 20 for which the writing pen 40 has moved thereon. In other words, only the pixel 10 on which the writing pen 40 is positioned, is turned off when the second section 452 is pressed down.

The receiver 30 is electrically connected with the control circuit 14 of the array 100. The receiver 30 includes a first terminal 31, a second terminal 32, a third terminal 33, a fourth terminal 34 and a fifth terminal 35. The first terminal 31 is configured to receive the first signal from the writing pen 40 and transmit the first signal to the control circuits 14. After the control circuits 14 of the pixels 10 receive the first signal, only the first light sources 11 in the pixels 10 will emit light when the writing pen 40 contacts the touch panel 20. The second terminal 32 is configured to receive the second signal from the writing pen 40 and transmit the second signal to the control circuits 14. After the control circuits 14 receive the second signal, only the second light sources 12 in the pixels 10 will emit light when the writing pen 40 contacts the touch panel 20. The third terminal 33 is configured to receive the third signal from the writing pen 40 and transmit the third signal to the control circuits 14. After the control circuits 14 receive the third signal, only the third light sources 13 in the pixels 10 will emit light when the writing pen 40 contacts the touch panel 20. The fourth terminal 34 is configured to receive the fourth signal from the writing pen 40 and transmit the fourth signal to the control circuits 14. After the control circuits 14 receive the fourth signal, all of the first light source 11, the second light source 12 and the third light source 13 in the pixels 10 will emit light to form a white light when the writing pen 40 contacts the touch panel 20. The fifth terminal 35 is configured to receive the erasing signal from the writing pen 40 and transmit to the control circuits 14. After the control circuits 14 receive the erasing signal, the control circuit 14 will turn off all or a part of the pixels 10 in the light emitting diode display panel 200. In this embodiment, if the first section 451 is pressed down, all of the pixels 10 in the light emitting diode display panel 200 are turned off. If the second section 452 is pressed down, only the pixel 10 on which the writing pen 40 is located is turned off.

As described above, the light emitting diode display panel 200 illustrates information according to the moving track of the writing pen 40 on the touch panel 20. No dust is generated in the above process. In addition, the pixels 10 each including the first light source 11, the second light source 12 and the third light source 13 can emit light of different colors. Therefore the track can be illustrated in multiple colors to meet different requirements.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A writing device, comprising:
a writing pen; and
a light emitting diode display panel, comprising:
an array having a plurality of pixels arranged in a matrix, each pixel comprising a first light source and a control circuit; and
a touch panel electrically connected with the array, the touch panel sensing a contact of the writing pen thereon and generating a control signal to the control circuit, the control circuit turning on the first light source in the pixel according to the control signal, wherein when the writing pen moves on the touch panel, the first light sources of the pixels corresponding to a moving track of the writing pen are sequentially turned on to illustrate the moving track of the writing pen on the touch panel.

2. The writing device of claim 1, wherein each of the pixels further comprises a second light source and a third light source, the first light source emits a red light, the second light source emits a green light, and the third light source emits a blue light.

3. The writing device of claim 2, wherein the control circuit selectively turns on at least one of the first light source, the second light source and the third light source.

4. The writing device of claim 3, wherein the writing pen comprises a first selective button, a second selective button and a third selective button, when the first selective button is pressed down, the writing pen generates a first signal to the control circuit to turn on the first light source in the pixel only when the writing pen contacts the touch panel, when the second selective button is pressed down, the writing pen generates a second signal to the control circuit to turn on the second light source in the pixel only when the writing pen contacts the touch panel, when the third selective button is pressed down, the writing pen generates a third signal to the control circuit to turn on the third light source in the pixel only when the writing pen contacts the touch panel.

5. The writing device of claim 4, wherein the writing pen further comprises a fourth selective button, when the fourth selective button is pressed down, the writing pen generates a fourth signal to the control circuit to turn on all of the first light source, the second light source and the third light source in the pixel when the writing pen contacts the touch panel.

6. The writing device of claim 5, wherein the writing pen further comprises a fifth selective button, when the fifth selective button is pressed down, the writing pen generates an erasing signal to the control circuit to turn off corresponding pixels which have been turned on.

7. The writing device of claim 6, wherein the fifth selective button consists of a first section and a second section, when the first section of the fifth selective button is pressed down, the writing pen generates an erasing signal to the control circuit to turn off all of the pixels in the light emitting diode display panel which have been turned on, when the second section of the fifth selective button is pressed down, the writing pen generates an erasing signal to the control circuit to turn off a part of the pixels in the light emitting diode display panel which has been turned on and is corresponding to a part of the touch panel for which the writing pen contacts.

8. The writing device of claim 7, wherein the light emitting diode display panel further comprises a receiver having a first terminal, a second terminal, a third terminal, a fourth terminal, and a fifth terminal, the first terminal is configured to receive the first signal and transmit the first signal to the control circuit, the second terminal is configured to receive the second signal and transmit the second signal to the control circuit, the third terminal is configured to receive the third signal and transmit the third signal to the control circuit, the fourth terminal is configured to receive the fourth signal and transmit the fourth signal to the control circuit, and the fifth terminal is configured to receive the erasing signal and transmit the erasing signal to the control circuit.

9. The writing device of claim 2, wherein the first light source, the second light source, the third light source, and the control circuit are arranged in a matrix.

10. A light emitting diode display panel, comprising:
an array having a plurality of pixels arranged in a matrix, each pixel comprising a first light source and a control circuit; and
a touch panel electrically connected with the array, the touch panel sensing a contact of an object thereon and generating a control signal to the control circuit, the control circuit turning on the first light source according to the control signal, wherein when the object moves on the touch panel, the first light sources of the pixels on a moving track of the object are sequentially turned on to illustrate the moving track of the object on the touch panel.

11. The light emitting diode display panel of claim 10, wherein each of the pixels further comprises a second light source and a third light source, the first light source emits a red light, the second light source emits a green light, and the third light source emits a blue light.

12. The light emitting diode display panel of claim 11, wherein the control circuit selectively turns at least one of the first light source, the second light source and the third light source.

13. The light emitting diode display panel of claim 11, wherein the first light source, the second light source, the third light source, and the control circuit are arranged in a matrix.

14. A writing pen for a light emitting diode display panel having a touch panel and a plurality of pixels arranged in a matrix, comprising:
a first portion for contacting the touch panel;
a second portion extending from the first portion and configured for a user's grip of the writing pen; and
a third portion extending from one end of the second portion away from the first portion;
wherein the second portion comprises a first selective button, a second selective button and a third selective button, when the first selective button is pressed down, the writing pen generates a first signal to the pixels to emit a red light when the writing pen contacts the touch panel, when the second selective button is pressed down, the writing pen generates a second signal to the pixels to emit a green light when the writing pen contacts the touch panel, when the third selective button is pressed down, the writing pen generates a third signal to the pixels to emit a blue light when the writing pen contacts the touch panel.

15. The writing pen of claim 14, wherein the writing pen further comprises a fourth selective button, when the fourth selective button is pressed down, the writing pen generates a fourth signal to the pixels to emit a white light when the writing pen contacts the touch panel.

16. The writing pen of claim 15, wherein the writing pen further comprises a fifth selective button, when the fifth selective button is pressed down, the writing pen generates an erasing signal to turn off corresponding pixels in the light emitting diode display panel which have been turned on.

17. The writing pen of claim 16, wherein the fifth selective button consists of a first section and a second section, when the first section of the fifth selective button is pressed down, the writing pen generates an erasing signal to turn off all of the pixels in the light emitting diode display panel which have been turned on, when the second section of the fifth selective button is pressed down, the writing pen generates an erasing signal to turn off a part of the pixels in the light emitting diode display panel which is corresponding to a part of the touch panel for which the writing pen contacts.
